(19) United States
(12) Patent Application Publication
(10) Pub. No.: US 2024/0208106 A1
(43) Pub. Date: Jun. 27, 2024

(54) GRANULATOR, KNEADING ADJUSTMENT MECHANISM, AND METHOD OF MANUFACTURING RESIN PELLETS

(71) Applicant: THE JAPAN STEEL WORKS, LTD., Shinagawa-ku, Tokyo (JP)

(72) Inventors: Kyohei YATA, Tokyo (JP); Makoto ISHIKAWA, Tokyo (JP); Takashi SHIGEISHI, Tokyo (JP); Ryota FUKUI, Tokyo (JP)

(21) Appl. No.: 18/288,543

(22) PCT Filed: Dec. 27, 2021
(86) PCT No.: PCT/JP2021/048589

§ 371 Date: Oct. 26, 2023

(30) Foreign Application Priority Data
May 11, 2021 (JP) 2021-080412

(51) Int. Cl. B29B 7/42; B29B 7/34; B29B 7/58; B29B 9/06

(52) U.S. Cl. CPC B29B 7/421; B29B 7/34; B29B 9/06; B29B 7/586; B29B 7/588

(57) ABSTRACT

A kneading adjustment mechanism 80 includes a pair of movable members 81 and 82 each having a flow path forming surface 85 constituting a part of a flow path 20 through which kneaded molten resin is conveyed and a screw 84 arranged between the flow path forming surfaces 85 of the respective movable members 81 and 82. At least one of the pair of movable members 81 and 82 can operate such that a gap between the flow path forming surface 85 and the screw 84 increases or decreases, and at least one or a plurality of protrusions 86 is provided on an outer periphery of the screw 84.

### TECHNICAL FIELD

The present invention relates to an apparatus and method for manufacturing resin pellets.

### BACKGROUND ART

An apparatus and method for manufacturing resin pellets by cutting molten resin while extruding it have been known. For example, Patent Document 1 discloses an underwater cutting granulator configured to cut molten resin extruded from a nozzle of a die head underwater.

### RELATED ART DOCUMENTS

### Patent Documents

Patent Document 1: Japanese Unexamined Patent Application Publication No. 2019-51617

### SUMMARY OF THE INVENTION

### Problems to be Solved by the Invention

It is desired to knead the molten resin more uniformly in the manufacture of resin pellets.

Other problems and novel features will be apparent from the descriptions of this specification and accompanying drawings.

### Means for Solving the Problem

According to an embodiment, a kneading adjustment mechanism includes a pair of movable members each having a flow path forming surface constituting a part of a flow path through which kneaded molten resin is conveyed and a screw arranged between the flow path forming surfaces of the respective movable members. At least one of the pair of movable members can operate such that a gap between the flow path forming surface and the screw increases or decreases. Further, at least one or a plurality of protrusions is provided on an outer periphery of the screw.

### Effects of the Invention

According to an embodiment, molten resin is kneaded more uniformly.

### BRIEF DESCRIPTIONS OF THE DRAWINGS

FIG. 1 is a schematic diagram showing a configuration of a granulator according to an embodiment;

FIG. 2 is a cross-sectional view showing a structure of a kneading processing unit;

FIG. 3 is a perspective view showing a structure of a kneading adjustment section;

FIG. 4A is a cross-sectional view showing movable members rotated until a cross-sectional area of a gate part becomes minimum;

FIG. 4B is a cross-sectional view showing movable members rotated until the cross-sectional area of the gate part becomes maximum;

FIG. 5A is a perspective view showing a screw constituting the kneading adjustment mechanism;

FIG. 5B is a cross-sectional view showing the screw in FIG. 5A and movable members around the screw;

FIG. 6A is a perspective view showing a modification of the screw constituting the kneading adjustment mechanism;

FIG. 6B is a cross-sectional view showing the screw in FIG. 6A and movable members around the screw;

FIG. 7A is a perspective view showing another modification of the screw constituting the kneading adjustment mechanism;

FIG. 7B is a cross-sectional view showing the screw in FIG. 7A and movable members around the screw;

FIG. 8A is a perspective view showing another modification of the screw constituting the kneading adjustment mechanism;

FIG. 8B is a cross-sectional view showing the screw in FIG. 8A and movable members around the screw;

FIG. 9A is a perspective view showing another modification of the screw constituting the kneading adjustment mechanism;

FIG. 9B is a cross-sectional view showing the screw in FIG. 9A and movable members around the screw;

FIG. 10 is a table showing simulation results;

FIG. 11A is a perspective view showing a screw provided in a granulator according to another embodiment;

FIG. 11B is a cross-sectional view showing the screw in FIG. 11A and movable members around the screw;

FIG. 12A is a perspective view showing a screw provided in a granulator according to another embodiment;

FIG. 12B is a cross-sectional view showing the screw in FIG. 12A and movable members around the screw;

FIG. 13A is a perspective view showing a screw provided in a granulator according to another embodiment;

FIG. 13B is a cross-sectional view showing the screw in FIG. 13A and movable members around the screw;

FIG. 14A is a perspective view showing a screw provided in a granulator according to another embodiment; and

FIG. 14B is a cross-sectional view showing the screw in FIG. 14A and movable members around the screw.

### DETAILED DESCRIPTION OF PREFERRED EMBODIMENTS

Hereinafter, an embodiment will be described in detail with reference to drawings. Note that the members and devices having the same or substantially same function are denoted by the same reference characters throughout the drawings for describing the embodiment, and the repetitive description thereof will be omitted.

### <Overall Configuration>

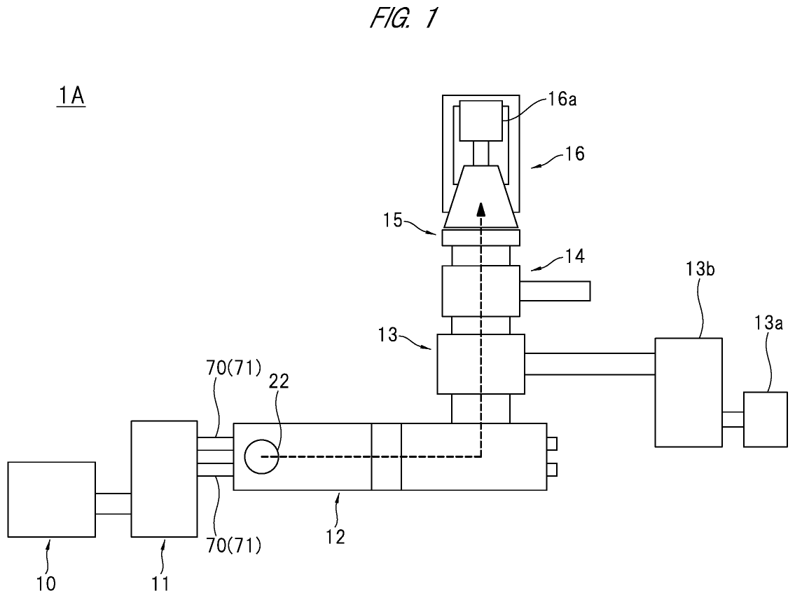

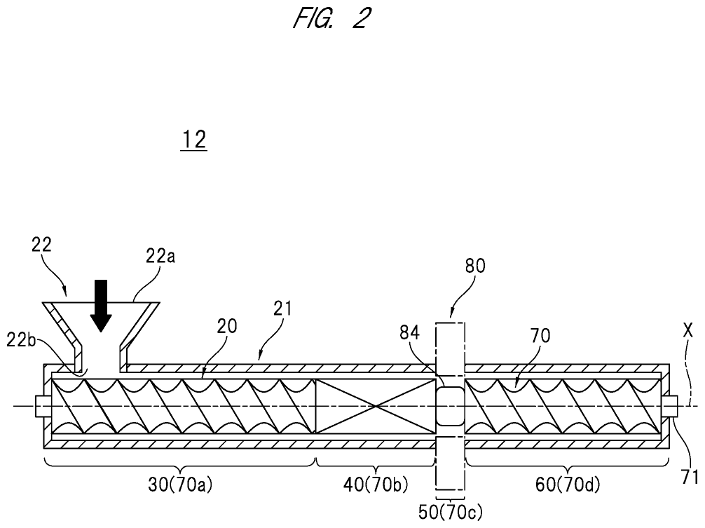

FIG. 1 is a schematic diagram showing a configuration of a granulator according to an embodiment. FIG. 2 is a cross-sectional view showing a structure of a kneading processing unit provided in the granulator in FIG. 1. A granulator 1A shown in FIG. 1 includes a main motor 10, a decelerator 11, a kneading processing unit 12, a gear pump 13, a foreign matter removing unit (screen changer) 14, a die head 15, and a cutting unit (pelletizer, cutter unit) 16.

### <Main Motor, Decelerator>

The main motor 10 is a drive source of the kneading processing unit 12. A rotational driving force output from the main motor 10 is input to a screw 70 of the kneading processing unit 12 through the decelerator 11, and rotates the screw 70. The decelerator 11 reduces the speed of the rotational driving force output from the main motor 10 and increases the torque of the rotational driving force input to the screw 70.

### <Kneading Processing Unit>

The kneading processing unit 12 conveys a resin raw material while melting it by the rotating screw 70. Further, the kneading processing unit 12 conveys the molten resin raw material (molten resin) while kneading it by the rotating screw 70.

As shown in FIG. 2, the kneading processing unit 12 includes a cylinder (barrel) 21 that forms a flow path (conveyance path) 20 through which a resin raw material and molten resin are conveyed. A raw material hopper 22 is provided on one end side of the cylinder 21 in a longitudinal direction. The raw material hopper 22 has an upper opening 22a and a lower opening 22b that is smaller than the upper opening 22a and communicates with the cylinder 21.

The resin raw material is put into the raw material hopper 22 from the upper opening 22a. The resin raw material put into the raw material hopper 22 falls into the cylinder 21 through the lower opening 22b. From another point of view, the resin raw material is supplied to the flow path 20 through the raw material hopper 22. In the following description, the upper opening 22a of the raw material hopper 22 is referred to as an “inlet port 22a”, and the lower opening 22b of the raw material hopper 22 is referred to as an “outlet port 22b” in some cases.

The resin raw material supplied to the flow path 20 is conveyed from one end side of the cylinder 21 where the raw material hopper 22 is provided toward the other end side. Namely, one end side of the cylinder 21 (left side in FIG. 2) where the raw material hopper 22 is provided is the upstream side of the flow path 20, and the other end side of the cylinder 21 (right side in FIG. 2) is the downstream side of the flow path 20.

The kneading processing unit 12 includes at least a conveyance section 30, a kneading section 40, a kneading adjustment section 50, a discharge section 60, and a screw 70 in addition to the cylinder 21 and the raw material hopper 22. The screw 70 is provided inside the cylinder 21 and is rotatably supported. From another point of view, the screw 70 is rotatably provided inside the flow path 20. As described above, the screw 70 is rotationally driven by the main motor 10.

A similar screw 70 is provided behind the screw 70 shown in FIG. 2 (see FIG. 1). These two screws 70 are arranged parallel to each other and are similarly rotationally driven by the main motor 10. In other words, the granulator 1A includes two screws 70 that are parallel to each other, and is generally referred to as a “twin-screw granulator” or a “twin-screw extruder”. In the following description, the two screws 70 provided in the granulator 1A will be collectively referred to as the “screw 70”. Further, the description of the screw 70 shown in FIG. 2 is also the description of the other screw 70 not shown in FIG. 2.

The conveyance section 30, the kneading section 40, the kneading adjustment section 50, and the discharge section 60 are provided on the flow path 20. Also, the conveyance section 30, the kneading section 40, the kneading adjustment section 50, and the discharge section 60 are arranged in a line along the flow path 20 in this order. In other words, the conveyance section 30, the kneading section 40, the kneading adjustment section 50, and the discharge section 60 are arranged in a line along the central axis X of the screw 70 in this order.

### <Gear Pump, Foreign Matter Removing Unit>

Refer to FIG. 1 again. The gear pump 13 supplies (pumps) the molten resin kneaded by the kneading processing unit 12 to the die head 15 through the foreign matter removing unit (screen changer) 14. The gear pump 13 is driven by a motor 13a. The rotational driving force output from the motor 13a is input to the gear pump 13 via a decelerator 13b. The foreign matter removing unit 14 removes unnecessary components, residues, contaminants, and others from the molten resin passing therethrough.

### <Die Head>

The die head 15 is composed of a die holder, a die plate, a die plate cover, and others, and includes a plurality of nozzles through which molten resin is extruded. The molten resin supplied to the die head 15 through the foreign matter removing unit 14 is formed into a strand shape (string shape, rope shape) by being extruded from the nozzles of the die head 15.

### <Cutting Unit>

The cutting unit 16 includes a cutting processing section that receives the strand-shaped molten resin extruded from the nozzles of the die head 15. The cutting processing section is provided on a flow path of water (pellet conveying water) that circulates in the resin pellet manufacturing system including the granulator 1A. During the operation of the manufacturing system, the cutting processing section is filled with the pellet conveying water. Namely, the molten resin formed into a strand shape by the die head 15 is extruded into water (into the pellet conveying water).

A cutter head to be rotationally driven is provided in the cutting processing section of the cutting unit 16. A plurality of cutter blades is attached to the cutter head. The cutter head is driven by a motor 16a and cuts the strand-shaped molten resin extruded from the die head 15 into a predetermined length.

### <Method of Manufacturing Resin Pellets>

In the granulator 1A, for example, resin pellets are manufactured through the following steps. First, a resin raw material is supplied to the kneading processing unit 12. More specifically, a resin raw material is put into the raw material hopper 22. The resin raw material supplied to the kneading processing unit 12 is, for example, a thermoplastic resin. More specifically, for example, a polyolefin resin having a bimodal structure is supplied to the kneading processing unit 12. Additives and the like are added to the resin raw material as necessary.

The resin raw material supplied to the kneading processing unit 12 is conveyed from the upstream side to the downstream side of the flow path 20 by the rotating screw 70. The resin raw material (molten resin) conveyed in the flow path 20 is melted and kneaded during its conveyance. More specifically, the resin raw material (molten resin) is melted and kneaded while passing through the conveyance section 30, the kneading section 40, the kneading adjustment section 50, and the discharge section 60 in this order. Each step will be described in more detail below.

The resin raw material put into the input port 22a of the raw material hopper 22 shown in FIG. 2 is supplied to the conveyance section 30. The resin raw material supplied to the conveyance section 30 is conveyed to the downstream side of the flow path 20 while being melted (melting step). Next, the resin raw material (molten resin) melted in the melting step is conveyed to the kneading section 40. The molten resin supplied to the kneading section 40 is conveyed to the further downstream side of the channel 20 while being kneaded (mixed) (kneading step).

In the melting step described above, the resin raw material is melted mainly by heat generated by the shearing action caused by the rotation of the screw 70. Further, in the kneading step described above, the molten resin is kneaded (dispersive mixing and distributive mixing) mainly by the shearing action and elongation action caused by the rotation of the screw 70. Note that the heat generation of the molten resin continues even during the kneading step. At least, the temperature of the molten resin during the kneading step is maintained within a predetermined temperature range by the heat generation. Understandably, if necessary, the resin raw material or molten resin may be heated by heating means such as a heater, or the resin raw material or molten resin may be cooled by cooling means.

The molten resin kneaded in the kneading step is supplied (discharged) to the gear pump 13 shown in FIG. 1 through the kneading adjustment section 50 and the discharging section 60. In the kneading adjustment section 50, a step (kneading adjustment step) of adjusting the degree of kneading (kneading degree) of the molten resin in the kneading step is executed. The kneading adjustment section 50 will be described again later.

The molten resin supplied to the gear pump 13 is supplied (pumped) to the die head 15 through the foreign matter removing unit 14. In the foreign matter removing unit 14, volatile components contained in the molten resin, catalyst residues, foreign matters mixed in from the outside, and others are removed (foreign matter removing step).

The molten resin pumped to the die head 15 is continuously extruded from the plurality of nozzles provided in the die head 15 (extruding step). The molten resin is formed into a strand shape (string shape, rope shape) by passing through the nozzles of the die head 15.

The strand-shaped molten resin extruded from the nozzles of the die head 15 is cut into a predetermined length and is solidified in the cutting processing section of the cutting unit 16 (cutting/solidifying step, pelletizing step). Namely, the molten resin extruded into a strand shape is divided into pellets. As a result, resin pellets of a predetermined size (length and thickness) are manufactured.

As described above, the cutting processing section of the cutting unit 16 is filled with water (pellet conveying water), and the molten resin is cut in water (pellet conveying water). The method of cutting molten resin underwater in this manner is referred to as “underwater cutting” in some cases.

Note that, depending on the characteristics (especially melting point) of the resin raw material, resin pellets may be manufactured without circulating the pellet conveying water. In this case, the molten resin extruded from the nozzles of the die head 15 is cut in the cutting processing section where the pellet conveying water is not present. Namely, the extruded molten resin is cut in the air. The method of cutting molten resin in the air in this manner is referred to as “hot cutting” in some cases.

Now return to the description of the method of manufacturing resin pellets according to the present embodiment in which underwater cutting is performed. The mixture (slurry) of resin pellets and pellet conveying water sent out from the cutting processing section is separated into resin pellets and pellet conveying water (dehydration step). Next, the resin pellets separated from the pellet conveying water are sent to a storage container such as a pellet silo (transfer step). The resin pellets are sent to a pellet silo by, for example, an airflow generated by a blower.

In the method of manufacturing resin pellets according to the present embodiment, resin pellets are manufactured through the steps described above. Understandably, the method of manufacturing resin pellets can be modified in various ways depending on the types and characteristics of the resin raw material, the resin pellets, and others. For example, in another embodiment, a drying step is executed after the dehydration step. In the drying step, the water that could not be removed in the dehydration step is removed from the resin pellets by using a centrifugal dehydrator or the like. In still another embodiment, after the dehydration step and the drying step, a sorting step of sorting the resin pellets based on size is executed.

### <Kneading Processing Unit>

Next, the kneading processing unit 12 of the granulator 1A will be described in more detail. As shown in FIG. 2, the kneading processing unit 12 includes the conveyance section 30, the kneading section 40, the kneading adjustment section 50, and the discharge section 60 provided along the longitudinal direction of the cylinder 21 (flow path 20) and the screw 70. From another point of view, the cylinder 21 (flow path 20) and the screw 70 can be sectionalized into the conveyance section 30, the kneading section 40, the kneading adjustment section 50, and the discharge section 60 based on their functions.

As mentioned above, the conveyance section 30 is constituted of a part of the cylinder 21 and the screw 70. Further, the kneading section 40 is constituted of another part of the cylinder 21 and the screw 70, the kneading adjustment section 50 is constituted of another part of the screw 70, and the discharge section 60 is constituted of still another part of the cylinder 21 and the screw 70.

In the following description, a part of the cylinder 21 constituting the conveyance section 30 is referred to as an “upstream section”, another part of the cylinders 21 constituting the kneading section 40 is referred to as a “midstream section”, and still another part of the cylinder 21 constituting the discharge section 60 is referred to as a “downstream section” in some cases as a matter of distinction. Understandably, such a distinction is merely a distinction for convenience of description.

Further, in the following description, a part of the screw 70 constituting the conveyance section 30 is referred to as a “conveyance screw section 70a”, another part of the screw 70 constituting the kneading section 40 is referred to as a “former kneading screw section 70b”, another part of the screw 70 constituting the kneading adjustment section 50 is referred to as a “latter kneading screw section 70c”, and still another part of the screw 70 constituting the discharge section 60 is referred to as a “discharge screw section 70d” in some cases as a matter of distinction. Such a distinction is also merely a distinction for convenience of description.

### <Screw>

The screw 70 includes flights and protrusions provided on a shaft 71 extending from one end to the other end of the cylinder 21. More specifically, flights are provided on the outer periphery of the conveyance screw section 70a, the former kneading screw section 70b, and the discharge screw section 70d of the screw 70. In addition, protrusions are provided on the outer periphery of the latter kneading screw section 70c of the screw 70.

The flights and protrusions provided on the screw 70 are formed of kneading disks, rotors, segments, and the like attached to the shaft 71, or are integrally formed with the shaft 71. The form (structure, shape, size, pitch, etc.) of the flights provided on the screw 70 is determined as appropriate depending on the purpose of each flight, the type of resin, and others.

The flights provided on a part of the screw 70 (conveyance screw section 70a and discharge screw section 70d) of the present embodiment are mainly intended for the conveyance of the resin raw materials and molten resin. On the other hand, the flights provided on another part of the screw 70 (former kneading screw section 70b) of the present embodiment are mainly intended for the kneading of the molten resin.

Therefore, in the present embodiment, the flights provided on the conveyance screw section 70a and the discharge screw section 70d are formed of helical blades integrally formed with the shaft 71. On the other hand, the flights provided on the former kneading screw section 70b of the screw 70 are formed of a plurality of kneading disks or rotors attached to the shaft 71. Note that the protrusions provided on the latter kneading screw section 70c of the screw 70 will be described later.

### <Kneading Adjustment Section>

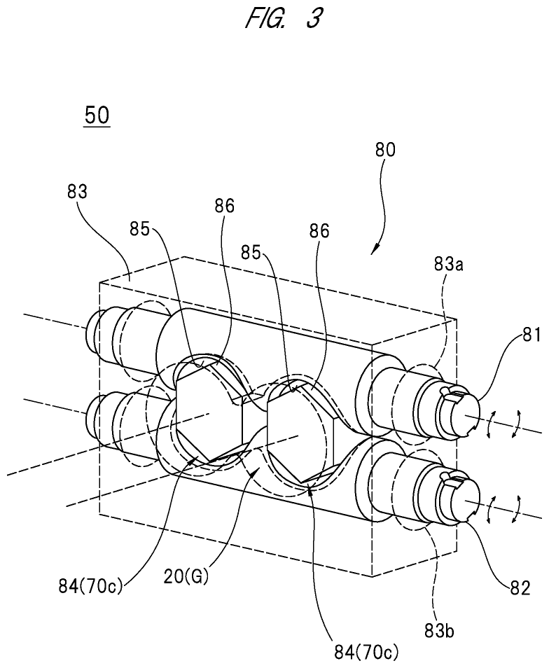

FIG. 3 is a perspective view showing a structure of the kneading adjustment section 50. The kneading adjustment section 50 is provided on the downstream side than the kneading section 40 on the flow path 20. The kneading adjustment section 50 forms a part of the flow path 20 and includes a kneading adjustment mechanism 80 configured to adjust the degree of kneading of the molten resin.

The kneading adjustment mechanism 80 adjusts the degree of kneading of the molten resin by changing the cross-sectional area of a part of the flow path 20 constituted of the kneading adjustment section 50. Furthermore, the kneading adjustment mechanism 80 itself also kneads the molten resin.

The kneading adjustment mechanism 80 is composed of a pair of movable members 81 and 82, a holding block 83, and screws 84. Understandably, the screw 84 constituting the kneading adjustment mechanism 80 is a part of the screw 70. More specifically, the screw 84 constituting the kneading adjustment mechanism 80 is the latter kneading screw section 70c of the screw 70.

The movable members 81 and 82 are metal rods held rotatably. Each of the movable members 81 and 82 is rotatably held by the holding block 83 that is arranged between the midstream section and the downstream section of the cylinder 21 and forms a part of the flow path 20. The holding block 83 is provided with an upper holding portion 83a that crosses the upper side of the flow path 20 and a lower holding portion 83b that crosses the lower side of the flow path 20. The upper holding portion 83a and the lower holding portion 83b orthogonally cross the flow path 20 and extend parallel to each other.

The movable member 81 is inserted into the upper holding portion 83a, and the movable member 82 is inserted into the lower holding portion 83b. As a result, the movable member 81 orthogonally crosses the upper side of the flow path 20, and the movable member 82 orthogonally crosses the lower side of the flow path 20. Further, a part of the outer peripheral surface of the movable member 81 is exposed to the flow path 20, and a part of the outer peripheral surface of the movable member 82 is also exposed to the flow path 20. From another point of view, the movable members 81 and 82 form a part of the flow path 20 together with the holding block 83.

On both sides of the respective movable members 81 and 82 in the longitudinal direction, gears that mesh with each other are formed around the entire circumference. Therefore, when at least one movable member rotates, both movable members simultaneously rotate in opposite directions. For example, when the movable member 81 on the upper side rotates clockwise, the movable member 82 on the lower side simultaneously rotates counterclockwise. Namely, the two movable members 81 and 82 rotate in opposite directions in conjunction with each other. Then, the cross-sectional area of a part of the flow path 20 changes (increases or decreases) depending on the rotation angle (rotation amount) of the movable members 81 and 82.

As described above, the kneading adjustment mechanism 80 is provided on the downstream side than the kneading section 40. More specifically, the kneading adjustment mechanism 80 is provided between the midstream section and the downstream section of the cylinder 21. In other words, the kneading adjustment mechanism 80 is provided between the kneading section 40 and the discharge section 60. As a result, the cross-sectional area of a part (region) of the flow path 20 connecting the kneading section 40 and the discharge section 60 is changed by the kneading adjustment mechanism 80. In the following description, a part (region) of the flow path 20 whose cross-sectional area is changed by the kneading adjustment mechanism 80 is referred to as a “gate part G” in some cases.

The gate part G is located on the downstream side than the kneading section 40. Therefore, when the cross-sectional area of the gate part G is changed by the kneading adjustment mechanism 80, the pressure (back pressure) of the molten resin in the gate part G changes. Specifically, when the cross-sectional area of the gate part G is reduced by the kneading adjustment mechanism 80, the pressure of the molten resin in the gate part G increases. On the other hand, when the cross-sectional area of the gate part G is increased by the kneading adjustment mechanism 80, the pressure of the molten resin in the gate part G decreases. Then, when the pressure of the molten resin in the gate part G increases, the time for which the molten resin is kneaded in the kneading section 40 becomes longer, and the degree of kneading increases (becomes higher). On the other hand, when the pressure of the molten resin in the gate part G decreases, the time for which the molten resin is kneaded in the kneading section 40 becomes shorter, and the degree of kneading decreases (becomes lower). Namely, the kneading adjustment mechanism 80 controls the pressure of the molten resin in the gate part G by partially changing the cross-sectional area of the flow path 20, thereby adjusting the degree of kneading of the molten resin.

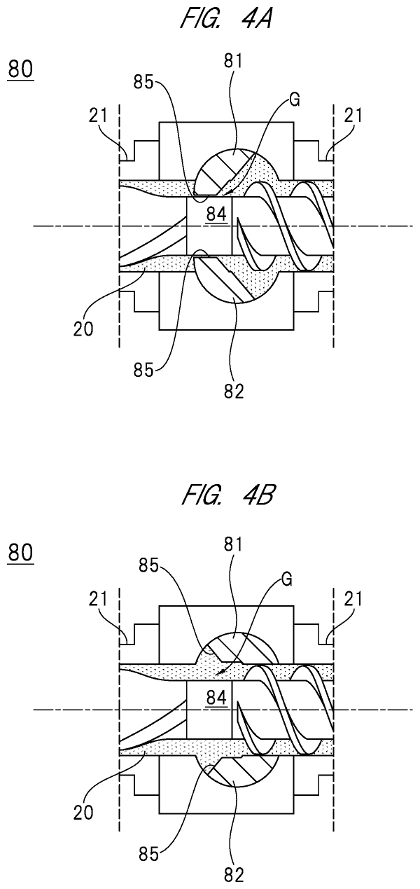

FIG. 4A is a cross-sectional view showing the movable members 81 and 82 rotated until the cross-sectional area of the gate part G becomes minimum. FIG. 4B is a cross-sectional view showing the movable members 81 and 82 rotated until the cross-sectional area of the gate part G becomes maximum.

The movable members 81 and 82 are provided with flow path forming surfaces 85 that form a part of the flow path 20 (gate part G). The flow path forming surfaces 85 of the movable members 81 and 82 each have a curved shape that follows the outer shape of the screw 84 (latter kneading screw section 70c), and are arranged on both sides (upper and lower sides) in the radial direction of the screw 84. From another point of view, the screw 84 is arranged between the flow path forming surface 85 of the movable member 81 and the flow path forming surface 85 of the movable member 82.

The flow path forming surface 85 of the movable member 81 which forms the upper side of the gate part G faces approximately the upper half of the screw 84, and the flow path forming surface 85 of the movable member 82 that forms the lower side of the gate part G faces approximately the lower half of the screw 84. In other words, the flow path forming surface 85 of the movable member 81 faces the upper side of the outer peripheral surface of the latter kneading screw section 70c, and the flow path forming surface 85 of the movable member 82 faces the lower side of the outer peripheral surface of the latter kneading screw section 70c. Understandably, the region on the screw 84 that faces the flow path forming surface 85 changes as the screw 84 rotates. Further, depending on the rotation angle (rotation amount) of the movable members 81 and 82, the flow path forming surface 85 and the screw 84 parallelly face each other or diagonally face each other.

When the movable member 81 shown in FIG. 4B rotates counterclockwise, the flow path forming surface 85 of the movable member 81 approaches the screw 84. At the same time, the movable member 82 rotates clockwise, and the flow path forming surface 85 of the movable member 82 also approaches the screw 84. As a result, the gap (clearance) between the flow path forming surfaces 85 of the movable members 81 and 82 and the screw 84 decreases. In other words, the cross-sectional area of the gate part G decreases.

On the other hand, when the movable member 81 shown in FIG. 4A rotates clockwise, the flow path forming surface 85 of the movable member 81 separates from the screw 84. At the same time, the movable member 82 rotates counterclockwise, and the flow path forming surface 85 of the movable member 82 also separates from the screw 84. As a result, the gap (clearance) between the flow path forming surfaces 85 of the movable members 81 and 82 and the screw 84 increases. In other words, the cross-sectional area of the gate part G increases.

As described above, the pair of movable members 81 and 82 can operate such that the gap (clearance) between the flow path forming surfaces 85 and the screw 84 increases or decreases. Then, as the gap (clearance) between the flow path forming surfaces 85 and the screw 84 increases or decreases, the cross-sectional area of the gate part G increases or decreases.

When the movable members 81 and 82 shown in FIG. 4B are each rotated by 50 degrees, they will be in the state shown in FIG. 4A (fully closed state). The cross-sectional area of the gate part G is minimum when the movable members 81 and 82 are in the fully closed state. On the other hand, when the movable members 81 and 82 shown in FIG. 4A are each rotated by 50 degrees, they will be in the state shown in FIG. 4B (fully open state). The cross-sectional area of the gate part G is maximum when the movable members 81 and 82 are in the fully open state. Further, the cross-sectional area of the gate part G gradually decreases as the movable members 81 and 82 shift from the fully open state to the fully closed state, and it gradually increases as the movable members 81 and 82 shift from the fully closed state to the fully open state.

Note that, by increasing or decreasing the gap (clearance) between the flow path forming surface 85 of at least one of the movable members 81 and 82 and the screw 84, the cross-sectional area of the gate part G can be increased or decreased. Further, by moving up or down the movable members 81 and 82, the gap (clearance) between the flow path forming surfaces 85 and the screw 84 can be increased or decreased.

### <Screw (Latter Kneading Screw Section)>

Next, the shape of the screw 84 constituting the kneading adjustment mechanism 80 will be described. Note that, as described above, the screw 84 is a part of the screw 70 (latter kneading screw section 70c).

The screw 84 has a shape capable of kneading the molten resin passing through the kneading adjustment section 50. More specifically, the screw 84 has a shape capable of the dispersive mixing of the molten resin passing through the kneading adjustment section 50.

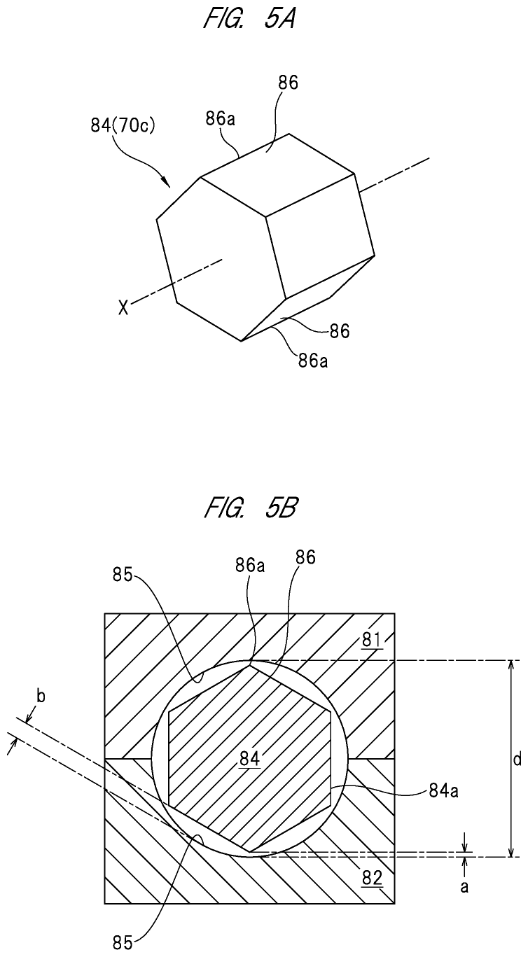

FIG. 5A is a perspective view of the screw 84. FIG. 5B is a cross-sectional view of the screw 84 shown in FIG. 5A and the movable members 81 and 82 around the screw 84. The cross section of the screw 84 shown in FIG. 5B is the cross section orthogonal to the central axis X. From the above description, it can be seen that the central axis X is the central axis of the screw 70 as well as the central axis of the screw 84. In the following description, unless otherwise specified, the cross section of the screw 70 (screw 84) means the cross section orthogonal to the central axis X. Note that the movable members 81 and 82 shown in FIG. 5B actually have such shapes as shown in FIG. 3, and are schematically shown in FIG. 5B.

At least one protrusion 86 is provided on the outer periphery of the screw 84. In the present embodiment, six protrusions 86 each having a corner are provided on the outer periphery of the screw 84. From another point of view, edges are provided at six locations in the circumferential direction of the screw 84.

The six protrusions 86 provided on the screw 84 are arranged at equal intervals (60 degree intervals) in the circumferential direction (rotation direction) of the screw 84. Further, the respective protrusions 86 extend parallel to the central axis X of the screw 84. As a result, the line segments connecting the vertices (tips) 86a of the respective protrusions 86 in the cross section of the screw 84 form a regular polygon (regular hexagon). Namely, the screw 84 has a regular hexagonal cross-sectional shape.

The screw 84 having the protrusions 86 provided on its outer periphery generates an elongation flow in the molten resin passing through the kneading adjustment section 50 (gate part G). Specifically, when the screw 84 rotates, the flow path forming surface 85 relatively approaches and separates from the tip of the protrusion 86 of the screw 84. As a result, the cross-sectional area of the flow path changes continuously, causing the elongation deformation of the molten resin.

From another point of view, by providing the protrusion 86 on the outer periphery of the screw 84, the elongation rate can be obtained in the kneading adjustment section 50. Namely, the molten resin kneaded (mixed) while passing through the kneading section 40 is kneaded (mixed) also while passing through the kneading adjustment section 50.

Here, if the cross-sectional area of the flow path is too small, kneading may become excessive, and if the cross-sectional area of the flow path is too large, kneading may become insufficient. In other words, if the clearance between the screw 84 and the flow path forming surfaces 85 is too small, there is a fear that kneading becomes excessive. On the other hand, if the clearance between the screw 84 and the flow path forming surfaces 85 is too large, there is a fear that kneading becomes insufficient.

Therefore, the ratio (b/a) between the minimum clearance a and the maximum clearance b shown in FIG. 5B is preferably 4 or less. Moreover, it is preferable that the minimum clearance a when the movable members 81 and 82 are in a fully closed state is 1/10 or less of the inner diameter d of the gate part G.

Note that the minimum clearance a shown in FIG. 5B is the clearance between the protrusion 86 of the screw 84 and the flow path forming surface 85. More specifically, it is the clearance between the tip of the protrusion 86 and the flow path forming surface 85. Further, the maximum clearance b shown in FIG. 5B is the clearance between a flat portion between two adjacent protrusions 86 and the flow path forming surface 85.

In the present embodiment, six protrusions 86 are provided on the outer periphery of the screw 84. Understandably, if at least one protrusion 86 is provided on the outer periphery of the screw 84, the elongation flow can be generated in the molten resin. Therefore, the number, shape, arrangement, and others of the protrusions 86 provided on the outer periphery of the screw 84 are not particularly limited. Then, some modifications of the screw 84 will be described below.

### Modification 1

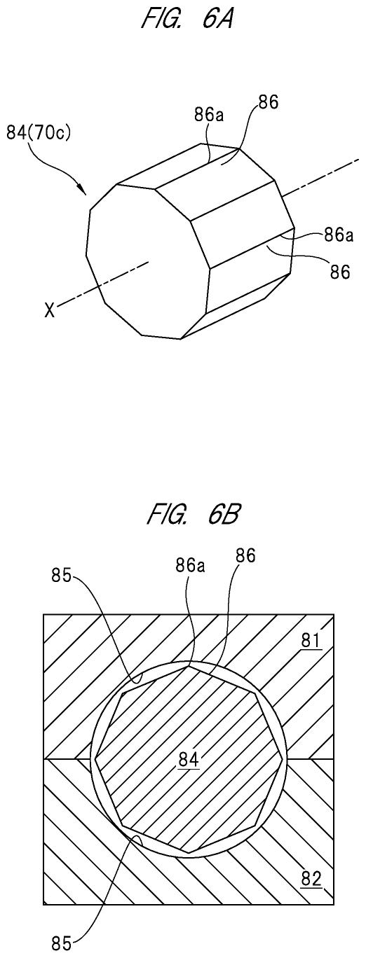

FIG. 6A is a perspective view showing a modification of the screw 84. FIG. 6B is a cross-sectional view of the screw 84 shown in FIG. 6A and the movable members 81 and 82 around the screw 84.

Eight protrusions 86 each having a corner are provided on the outer periphery of the screw 84 shown in FIG. 6A and FIG. 6B. These eight protrusions 86 are arranged at equal intervals (45 degree intervals) in the circumferential direction (rotation direction) of the screw 84. As a result, the line segments connecting the vertices 86a of the respective protrusions 86 in the cross section of the screw 84 form a regular polygon (regular octagon). Namely, the screw 84 shown in FIG. 6A and FIG. 6B has a regular octagonal cross-sectional shape.

### Modification 2

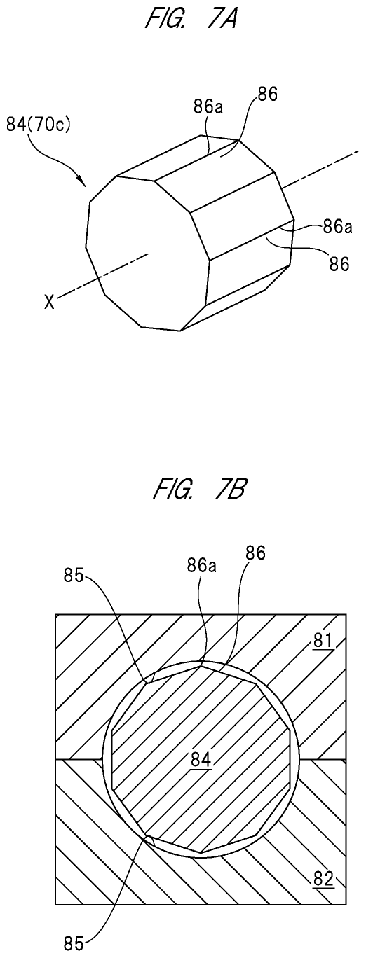

FIG. 7A is a perspective view showing another modification of the screw 84. FIG. 7B is a cross-sectional view of the screw 84 shown in FIG. 7A and the movable members 81 and 82 around the screw 84.

Ten protrusions 86 each having a corner are provided on the outer periphery of the screw 84 shown in FIG. 7A and FIG. 7B. These ten protrusions 86 are arranged at equal intervals (36 degree intervals) in the circumferential direction (rotation direction) of the screw 84. As a result, the line segments connecting the vertices 86a of the respective protrusions 86 in the cross section of the screw 84 form a regular polygon (regular decagon). Namely, the screw 84 shown in FIG. 7A and FIG. 7B has a regular decagonal cross-sectional shape.

### Modification 3

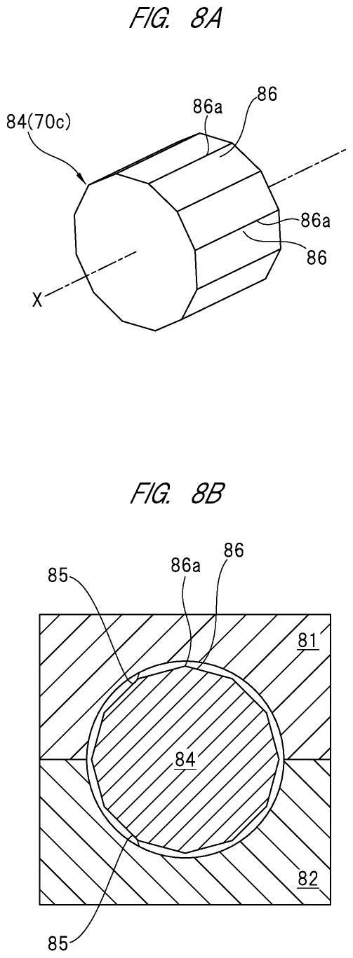

FIG. 8A is a perspective view showing another modification of the screw 84. FIG. 8B is a cross-sectional view of the screw 84 shown in FIG. 8A and the movable members 81 and 82 around the screw 84.

Twelve protrusions 86 each having a corner are provided on the outer periphery of the screw 84 shown in FIG. 8A and FIG. 8B. These twelve protrusions 86 are arranged at equal intervals (30 degree intervals) in the circumferential direction (rotation direction) of the screw 84. As a result, the line segments connecting the vertices 86a of the respective protrusions 86 in the cross section of the screw 84 form a regular polygon (regular dodecagon). Namely, the screw 84 shown in FIG. 8A and FIG. 8B has a regular dodecagonal cross-sectional shape.

### Modification 4

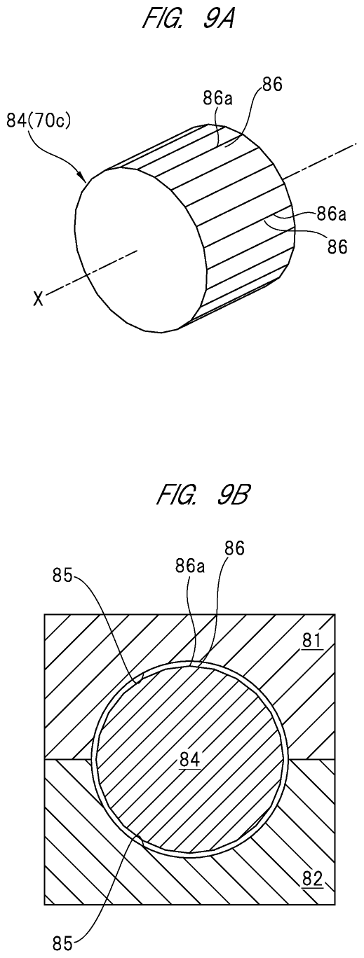

FIG. 9A is a perspective view showing another modification of the screw 84. FIG. 9B is a cross-sectional view of the screw 84 shown in FIG. 9A and the movable members 81 and 82 around the screw 84.

Twenty-four protrusions 86 each having a corner are provided on the outer periphery of the screw 84 shown in FIG. 9A and FIG. 9B. These twenty-four protrusions 86 are arranged at equal intervals (15 degree intervals) in the circumferential direction (rotation direction) of the screw 84. As a result, the line segments connecting the vertices 86a of the respective protrusions 86 in the cross section of the screw 84 form a regular polygon (regular icositetragon). Namely, the screw 84 shown in FIG. 9A and FIG. 9B has a regular icositetragonal cross-sectional shape.

### <Simulation>

Next, a simulation (flow analysis) performed to confirm the effects of the present embodiment will be described. In this simulation, the elongation rate that occurred in each molten resin with the same characteristics when a cylindrical screw with no protrusions on the outer periphery thereof and screws with protrusions on the outer periphery thereof were rotated under the same conditions was calculated. From another point of view, the elongation rate that occurred in each molten resin with the same characteristics when a screw whose cross-sectional shape was circular and screws whose cross-sectional shapes were regular polygonal were rotated under the same conditions was calculated.

Note that it was assumed that each screw was rotationally drive at the same speed in a cylinder under the same conditions. It was also assumed that the outer diameters of each screw were the same or substantially the same. As to the screws whose cross-sectional shapes were regular polygonal, the diameter of the circle connecting the vertices of respective protrusions was defined as the outer diameter of the screw.

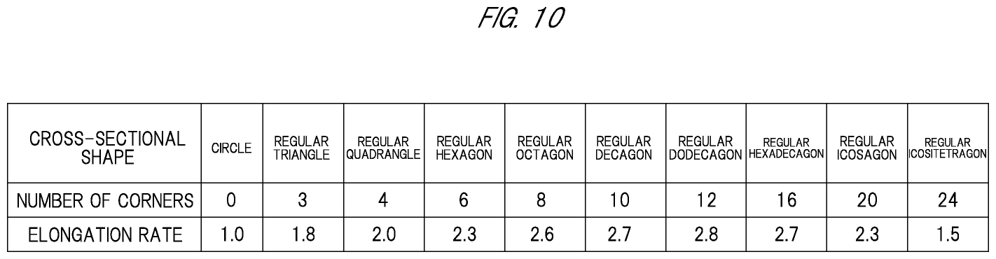

FIG. 10 shows the comparison results of the elongation rates calculated by this simulation. The table in FIG. 10 shows the ratio of the elongation rate obtained by each screw whose cross-sectional shape is regular polygonal to the elongation rate obtained by a screw whose cross-sectional shape is circular.

This simulation confirmed that the molten resin was kneaded (mixed) not only in the kneading section 40 but also in the kneading adjustment section 50 in the granulator 1A according to the present embodiment having the screw 84 whose cross-sectional shape was regular hexagonal. From another point of view, the kneading adjustment section 50 (kneading adjustment mechanism 80) provided in the granulator 1A according to the present embodiment has a kneading function and a kneading degree adjustment function. Therefore, with the granulator 1A according to the present embodiment, the resin can be kneaded more uniformly. The granulator 1A according to the present embodiment having such effects is particularly suitable for kneading resins with different viscosities, dispersing fillers with strong cohesive force, and the like.

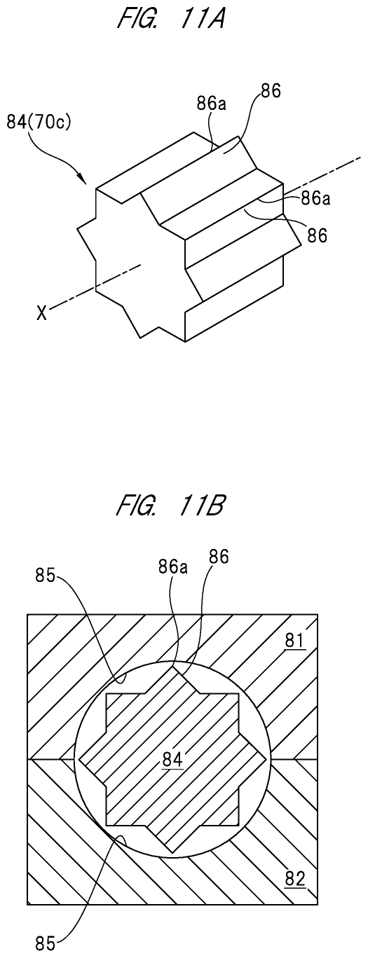

In the foregoing, the invention made by the inventors of this application has been concretely described based on the embodiments and examples. However, it is needless to say that the present invention is not limited to the above-described embodiments and examples, and various modifications can be made within the range not departing from the gist thereof. For example, it is sufficient that the screw 84 has at least one protrusion 86, and the cross-sectional shape thereof is not limited to a regular polygon. Therefore, the screw 84 of the embodiment described above can be replaced with, for example, screws 84 shown in FIG. 11 to FIG. 14.

FIG. 11A is a perspective view of the screw 84 provided in a granulator according to another embodiment. FIG. 11B is a cross-sectional view of the screw 84 shown in FIG. 11A and the movable members 81 and 82 around the screw 84.

Eight protrusions 86 each having a triangular cross-sectional shape are provided on the outer periphery of the screw 84 shown in FIG. 11A and FIG. 11B. From another point of view, this screw 84 has a generally star-like cross-sectional shape. From still another point of view, a plurality of peaks and valleys are provided on the outer periphery of the screw 84. Also, these peaks and valleys are arranged alternately in the circumferential direction.

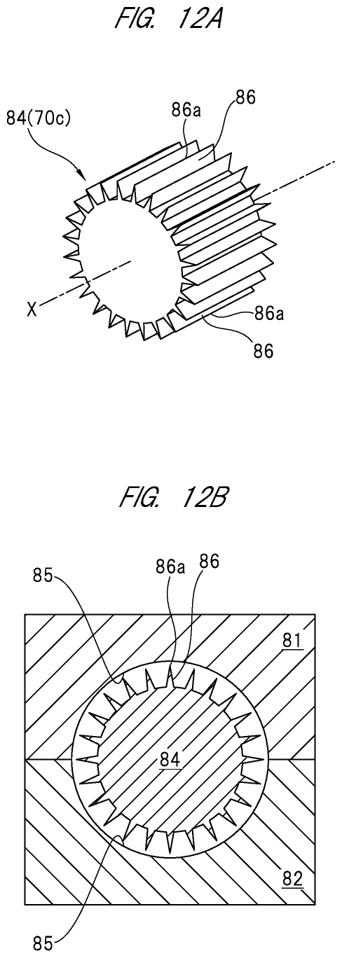

FIG. 12A is a perspective view of the screw 84 provided in a granulator according to still another embodiment. FIG. 12B is a cross-sectional view of the screw 84 shown in FIG. 12A and the movable members 81 and 82 around the screw 84.

Twenty-four protrusions 86 each having a triangular (wedge-shaped) cross-sectional shape are provided on the outer periphery of the screw 84 shown in FIG. 12A and FIG. 12B. The protrusions 86 provided on the screw 84 shown in FIG. 12A and FIG. 12B are sharper and are arranged at a narrower pitch than the protrusions 86 provided on the screw 84 shown in FIG. 11A and FIG. 11B. From another point of view, a plurality of thorns is provided on the outer periphery of the screw 84.

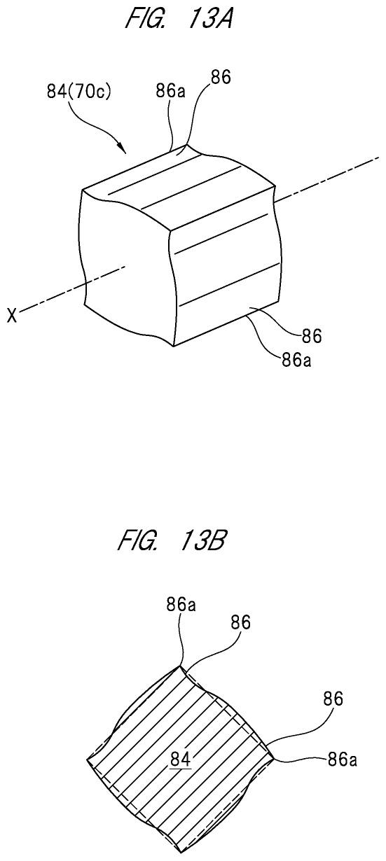

FIG. 13A is a perspective view of the screw 84 provided in a granulator according to still another embodiment. FIG. 13B is a cross-sectional view of the screw 84 shown in FIG. 13A.

Four protrusions 86 are provided on the outer periphery of the screw 84 shown in FIG. 13A and FIG. 13B. Further, the outer peripheral surfaces of the screw 84 connecting adjacent protrusions 86 are undulating (wavy). From another point of view, adjacent protrusions 86 are connected by curved surfaces. Note that, also in the screw 84 shown in FIG. 13A and FIG. 13B, the line segments connecting the vertices 86a of the respective protrusions 86 in the cross section orthogonal to the central axis X form a regular polygon (regular quadrangle).

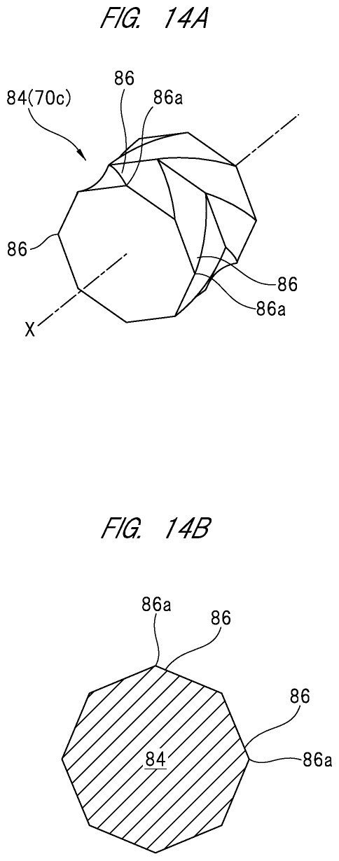

FIG. 14A is a perspective view of the screw 84 provided in a granulator according to still another embodiment. FIG. 14B is a cross-sectional view of the screw 84 shown in FIG. 14A.

Six protrusions 86 are provided on the outer periphery of the screw 84 shown in FIG. 14A and FIG. 14B. This screw 84 has a regular hexagonal cross-sectional shape like the screw 84 shown in FIG. 5A and FIG. 5B. However, the respective protrusions 86 provided on the screw 84 shown in FIG. 14A and FIG. 14B extend in directions intersecting the central axis X, whereas the respective protrusions 86 provided on the screw 84 shown in FIG. 5A and FIG. 5B extend parallel to the central axis X. From another point of view, the respective protrusions 86 provided on the screw 84 shown in FIG. 14A and FIG. 14B extend in a spiral manner with the central axis X as the pivot axis. Note that all the protrusions 86 provided on the screws 84 shown in FIG. 6 to FIG. 13 extend parallel to the central axis X.

In this specification, several examples of the shape of the screw 84 constituting the kneading adjustment mechanism 80 have been shown. However, the shapes of the screw 84 shown in this specification are merely examples. The shape, size, number, pitch, and others of the protrusions 86 provided on the screw 84 constituting the kneading adjustment mechanism 80 can be changed as appropriate depending on the stress to be applied to the molten resin passing through the kneading adjustment section 50. For example, the tip of the protrusion 86 does not have to be sharp. The tip of the protrusion 86 may be, for example, an arcuate surface. When the tip of the protrusion 86 is an arcuate surface, the midpoint of the arc corresponds to the vertex 86a of the protrusion 86.

Granulators include at least twin-screw granulators and single-screw granulators. Further, the twin-screw granulators include at least a continuous co-rotating intermeshing twin-screw granulator and a continuous counter-rotating non-intermeshing twin-screw granulator.

### REFERENCE SIGNS LIST

1A: granulator
10: main motor
11: decelerator
12: kneading processing unit
13: gear pump
13a, 16a: motor
13b: decelerator
14: foreign matter removing unit
15: die head
16: cutting unit
20: flow path
21: cylinder
22: raw material hopper
22a: upper opening (inlet port)
22b: lower opening (outlet port)
30: conveyance section
40: kneading section
50: kneading adjustment section
60: discharge section
70, 84: screw
70a: conveyance screw section
70b: former kneading screw section
70c: latter kneading screw section
70d: discharge screw section
71: shaft
80: kneading adjustment mechanism
81, 82: movable member
83: holding block
83a: upper holding portion
83b: lower holding portion
85: flow path forming surface
86: protrusion
86a: vertex
a: minimum clearance
b: maximum clearance
d: inner diameter
G: gate part
X: central axis

1. A granulator comprising:
a flow path through which molten resin is conveyed;
a kneading section provided on the flow path and configured to convey the molten resin while kneading it; and
a kneading adjustment section provided on a downstream side than the kneading section on the flow path,
wherein the kneading adjustment section includes a kneading adjustment mechanism including:
a pair of movable members each having a flow path forming surface constituting a part of the flow path; and
a screw arranged between the flow path forming surfaces of the respective movable members,
wherein at least one of the pair of movable members can operate such that a gap between the flow path forming surface and the screw increases or decreases, and
wherein at least one or a plurality of protrusions is provided on an outer periphery of the screw.

2. The granulator according to claim 1,
wherein the protrusion provided on the outer periphery of the screw has a corner.

3. The granulator according to claim 1,
wherein the plurality of protrusions is provided, and
wherein line segments connecting vertices of the respective protrusions in a cross section of the screw orthogonal to a central axis form a regular polygon.

4. The granulator according to claim 3,
wherein the respective protrusions extend parallel to the central axis of the screw.

5. The granulator according to claim 3,
wherein the respective protrusions extend in directions intersecting the central axis of the screw.

6. A kneading adjustment mechanism provided on a flow path through which kneaded molten resin is conveyed, the kneading adjustment mechanism comprising:
a pair of movable members each having a flow path forming surface constituting a part of the flow path; and
a screw arranged between the flow path forming surfaces of the respective movable members,
wherein at least one of the pair of movable members can operate such that a gap between the flow path forming surface and the screw increases or decreases, and
wherein at least one or a plurality of protrusions is provided on an outer periphery of the screw.

7. The kneading adjustment mechanism according to claim 6,
wherein the plurality of protrusions is provided, and
wherein line segments connecting vertices of the respective protrusions in a cross section of the screw orthogonal to a central axis form a regular polygon.

8. A method of manufacturing resin pellets comprising:
(a) kneading molten resin; and
(b) adjusting a degree of kneading of the molten resin in the (a),
wherein, in the (b), a cross-sectional area of a flow path through which the molten resin kneaded in the (a) is conveyed is changed by a kneading adjustment mechanism, thereby increasing or decreasing time for which the molten resin is kneaded in the (a),
wherein the kneading adjustment mechanism used in the (b) includes:
a pair of movable members each having a flow path forming surface constituting a part of the flow path; and
a screw arranged between the flow path forming surfaces of the respective movable members,
wherein at least one of the pair of movable members can operate such that a gap between the flow path forming surface and the screw increases or decreases, and
wherein at least one or a plurality of protrusions is provided on an outer periphery of the screw.

9. The method of manufacturing resin pellets according to claim 8,
wherein the plurality of protrusions is provided, and
wherein line segments connecting vertices of the respective protrusions in a cross section of the screw orthogonal to a central axis form a regular polygon.

10. The granulator according to claim 2,
wherein the plurality of protrusions is provided, and
wherein line segments connecting vertices of the respective protrusions in a cross section of the screw orthogonal to a central axis form a regular polygon.

11. The granulator according to claim 10,
wherein the respective protrusions extend parallel to the central axis of the screw.

12. The granulator according to claim 10,
wherein the respective protrusions extend in directions intersecting the central axis of the screw.
